(19) United States
(12) Patent Application Publication
(10) Pub. No.: US 2013/0332177 A1
(43) Pub. Date: Dec. 12, 2013

(54) APPARATUS AND METHOD FOR CODING A PORTION OF AN AUDIO SIGNAL USING A TRANSIENT DETECTION AND A QUALITY RESULT

(71) Applicant: Fraunhofer-Gesellschaft zur Foerderung der angewandten Forschung e.V., Munich (DE)

(72) Inventors: Christian HELMRICH, Erlangen (DE); Guillaume FUCHS, Erlangen (DE); Goran MARKOVIC, Nuernberg (DE)

(21) Appl. No.: 13/966,688

(22) Filed: Aug. 14, 2013

Related U.S. Application Data
(63) Continuation of application No. PCT/EP2012/052396, filed on Feb. 13, 2012.
(60) Provisional application No. 61/442,632, filed on Feb. 14, 2011.

(51) Int. Cl. G10L 19/00

(52) U.S. Cl. CPC G10L 19/00
USPC 704/500

(57) ABSTRACT

An apparatus for coding a portion of an audio signal to obtain an encoded audio signal for the portion of the audio signal includes a transient detector for detecting whether a transient signal is located in the portion of the audio signal to obtain a transient detection result, an encoder stage for performing first and second encoding algorithms on the audio signal, the first and second encoding algorithms having differing first and second characteristics, respectively, a processor for determining which encoding algorithm results in an encoded audio signal being a better approximation to the portion of the audio signal with respect to the other encoding algorithm to obtain a quality result, and a controller for determining whether the encoded audio signal for the portion of the audio signal is to be generated by either the first or the second encoding algorithm based on the transient-detection and quality results.

### CROSS-REFERENCE TO RELATED APPLICATIONS

This application is a continuation of copending International Application No. PCT/EP2012/052396, filed Feb. 13, 2012, which is incorporated herein by reference in its entirety, and additionally claims priority from U.S. Application No. 61/442,632, filed Feb. 14, 2011, which is also incorporated herein by reference in its entirety.

The present invention is related to audio coding and, particularly, to switched audio coding, where, for different time portions, the encoded signal is generated using different encoding algorithms.

### BACKGROUND OF THE INVENTION

Switched audio coders which determine different encoding algorithms for different portions of the audio signal are known. An example is the so-called extended adaptive multi-rate-wideband codec or AMR-WB+ codec defined in the International Standard 3GPP TS 26.290 V6.1.0 2004-12. In this technical specification, the coding concept is described, which extends the ACELP (Algebraic Code Excited Linear Prediction) based AMR-WB codec by adding TCX (Transform Coded Excitation), bandwidth extension, and stereo. The AMR-WB+ audio codec processes input frames equal to 2048 samples at an internal sampling frequency F_{S}. The internal sampling frequency is limited to the range 12,800 to 38,400 Hz. The 2048 sample frames are split into two critically sampled equal frequency bands. This results in two superframes of 1024 samples corresponding to the low-frequency (LF) and high-frequency (HF) bands. Each superframe is divided into four 256-samples frames. Sampling at the internal sampling rate is obtained by using a variable sampling conversion scheme, which re-samples the input signal. The LF and HF signals are then encoded using two different approaches. The LF signal is encoded and decoded using the “core” encoder/decoder, based on switched ACELP and TCX. In the ACELP mode, the standard AMR-WB codec is used. The HF signal is encoded with relatively few bits (16 bits/frame) using a bandwidth extension (BWE) method.

The parameters transmitted from encoder to decoder are the mode-selection bits, the LF parameters and HF signal parameters. The parameters for each 1024-sample superframe are decomposed into four packets of identical size. When the input signal is stereo, the left and right channels are combined into mono-signals for a ACELP-TCX encoding, whereas the stereo encoding receives both input channels. In the AMR-WB+ decoder structure, the LF and HF bands are decoded separately. Then, the bands are combined in a synthesis filterbank. If the output is restricted to mono only, the stereo parameters are omitted and the decoder operates in mono mode.

The AMR-WB+ codec applies LP (Linear Prediction) analysis for both the ACELP and TCX modes, when encoding the LF signal. The LP coefficients are interpolated linearly at every 64-sample sub-frame. The LP analysis window is a half-cosine of length 384 samples. The coding mode is selected based on closed-loop analysis-by-synthesis method. Only 256 sample frames are considered for ACELP frames, whereas frames of 256, 512 or 1024 samples are possible in TCX mode. The ACELP coding consists of long-term prediction (LTP) analysis and synthesis and algebraic codebook excitation. In the TCX mode, a perceptually weighted signal is processed in the transform domain. The Fourier transformed weighted signal is quantized using split multi-weight lattice quantization (algebraic vector quantization). The transform is calculated in 1024, 512 or 256 sample windows. The excitation signal is recovered by inverse filtering a quantized weighted signal through the inverse weighting filter. In order to determine whether a certain portion of the audio signal is to be encoded using the ACELP mode or the TCX mode, a closed-loop mode selection or an open-loop mode selection is used. In a closed-loop mode selection, 11 successive trials are used. Subsequent to a trial, a mode selection is made between two modes to be compared. The selection criterion is the average segmental SNR (Signal Noise Ratio) between the weighted audio signal and the synthesized weighted audio signal. Hence, the encoder performs a complete encoding in both encoding algorithms, a complete decoding in accordance with both encoding algorithms and, subsequently, the results of both encoding/decoding operations are compared to the original signal. Hence, for each encoding algorithm, i.e., ACELP on the one hand and TCX on the other hand, a segmental SNR value is obtained and the encoding algorithm having the better segmental SNR value or having a better average segmental SNR value determined over a frame by averaging over the segmental SNR values for the individual sub-frames is used.

An additional switched audio coding scheme is the so-called USAC coder (USAC=Unified Speech Audio Coding). This coding algorithm is described in ISO/IEC 23003-3. The general structure can be described as follows. First, there is a common pre/post processing system of an MPEG Surround functional unit to handle stereo or multi-channel processing and an enhanced SBR unit generating the parametric representation of the higher audio frequencies of the input signal. Then, there are two branches, one consisting of a modified advanced audio coding (AAC) tool path and the other consisting of a linear prediction coding (LP or LPC domain) based path, which in turn features either a frequency-domain representation or a time-domain representation of the LPC residual. All transmitted spectra for both, AAC and LPC, are represented in MDCT domain following quantization and arithmetic coding. The time-domain representation uses an ACELP excitation coding scheme. The functions of the decoder are to find the description of the quantized audio spectra or time-domain representation in the bitstream payload and to decode the quantized values and other reconstruction information. Hence, the encoder performs two decisions. The first decision is to perform a signal classification for frequency domain versus linear prediction domain mode decision. The second decision is to determine, within the linear prediction domain (LPD), whether a signal portion is to be encoded using ACELP or TCX.

For applying a switched audio coding scheme in scenarios, where a very low delay may be used, particular attention has to be paid to transform-based coding parts, since these coding parts introduce a certain delay which depends on the transform length and window design. Therefore, the USAC coding concept is not suitable to very low-delay applications due to the modified AAC coding branch having a considerable transform length and length adaptation (also known as block switching) involving transitional windows.

On the other hand, the AMR-WB+ coding concept was found to be problematic due to the encoder-side decision whether ACELP or TCX is to be used. ACELP provides a good coding gain, but may result in significant audio quality problems when a signal portion is not suitable for the ACELP coding mode. Hence, for quality reasons, one might be inclined to use TCX whenever the input signal does not contain speech. However, using TCX too much at low bitrates will result in bitrate problems, since TCX provides a relatively low coding gain. When one, therefore, looks more onto the coding gain, one might use ACELP whenever possible, but, as stated before, this can result in audio quality problems due to the fact that ACELP is not optimal, for example, for music and similar stationary signals.

The segmental SNR calculation is a quality measure, which determines the better coding mode only based on the result, i.e., whether the SNR between the original signal or the encoded/decoded signal is better, so that the encoding algorithm resulting in a better SNR is used. This, however, has to operate under bitrate constraints. Therefore, it has been found that only using a quality measure such as, for example, the segmental SNR measure does not always result in the best compromise between quality and bitrate.

### SUMMARY

According to an embodiment, an apparatus for coding a portion of an audio signal to acquire an encoded audio signal for the portion of the audio signal may have: a transient detector for detecting whether a transient signal is located in the portion of the audio signal to achieve a transient detection result; an encoder stage for performing a first encoding algorithm on the audio signal, the first encoding algorithm having a first characteristic, and for performing a second encoding algorithm on the audio signal, the second encoding algorithm having a second characteristic being different from the first characteristic; a processor for determining which encoding algorithm results in an encoded audio signal being a better approximation to the portion of the audio signal with respect to the other encoding algorithm to achieve a quality result; and a controller for determining whether the encoded audio signal for the portion of the audio signal is to be generated by either the first encoding algorithm or the second encoding algorithm based on the transient detection result and the quality result.

According to another embodiment, a method of coding a portion of an audio signal to acquire an encoded audio signal for the portion of the audio signal may have the steps of: detecting whether a transient signal is located in the portion of the audio signal to achieve a transient detection result; performing a first encoding algorithm on the audio signal, the first encoding algorithm having a first characteristic, and performing a second encoding algorithm on the audio signal, the second encoding algorithm having a second characteristic being different from the first characteristic; determining which encoding algorithm results in an encoded audio signal being a better approximation to the portion of the audio signal with respect to the other encoding algorithm to achieve a quality result; and determining whether the encoded audio signal for the portion of the audio signal is to be generated by either the first encoding algorithm or the second encoding algorithm based on the transient detection result and the quality result.

Another embodiment may have a computer program having a program code for performing, when running on a computer, the method of coding a portion of an audio signal in accordance with claim 14.

The present invention is based on the finding that a better decision between a first encoding algorithm suited for more transient signal portions and a second encoding algorithm suitable for more stationary signal portions can be obtained when the decision is not only based on a quality measure but, additionally, on a transient detection result. While the quality measure only looks at the result of the encoding/decoding chain with respect to the original signal, the transient detection result additionally relies on an analysis of the original input audio signal alone. Hence, it has been found out that a combination of both measures, i.e., the quality result on the one hand and the transient detection result on the other hand for finally determining whether a portion of an audio signal is to be encoded by which encoding algorithm leads to an improved compromise between coding gain on the one hand and audio quality on the other hand.

An apparatus for coding a portion of an audio signal to obtain an encoded audio signal for the portion of an audio signal comprises a transient detector for detecting whether a transient signal is located in the portion of the audio signal to obtain a transient detection result. The apparatus furthermore comprises an encoder stage for performing a first encoding algorithm on the audio signal, the first encoding algorithm having a first characteristic, and for performing a second encoding algorithm on the audio signal, the second encoding algorithm having a second characteristic being different from the first characteristic. In an embodiment, the first characteristic associated with the first encoding algorithm is better suited for a more transient signal, and the second encoding characteristic associated with the second encoding algorithm is better suited for more stationary audio signals. Exemplarily, the first encoding algorithm is an ACELP encoding algorithm and the second encoding algorithm is a TCX encoding algorithm which may be based on a modified discrete cosine transform, an FFT transform or any other transform or filterbank. Furthermore, a processor is provided for determining, which encoding algorithm results in an encoded audio signal being a better approximation to the portion of the audio signal to obtain a quality result. Furthermore, a controller is provided, where the controller is configured for determining whether the encoded audio signal for the portion of the audio signal is generated by either the first encoding algorithm or the second encoding algorithm. In accordance with the invention, the controller is configured for performing this determination not only based on the quality result but, additionally, on the transient detection result.

In an embodiment, the controller is configured for determining the second encoding algorithm, although the quality result indicates a better quality for the first encoding algorithm, when the transient detection result indicates a non-transient signal. Furthermore, the controller is configured for determining the first encoding algorithm, although the quality result indicates a better quality for the second encoding algorithm, when the transient detection result indicates a transient signal.

In a further embodiment, this determination, in which the transient result can negate the quality result, is enhanced using a hysteresis function such that the second encoding algorithm is only determined when a number of earlier signal portions, for which the first encoding algorithm has been determined, is smaller than a predetermined number. Analogously, the controller is configured to only determine the first encoding algorithm when a number of earlier signal portions, for which the second encoding algorithm has been determined in the past, is smaller than a predetermined number. An advantage from the hysteresis processing is that the number of switch-overs between coding modes is reduced for certain input signals. A too frequent switch-over at critical points in the signal may generate audible artifacts specifically for low bitrates. The probability of such artifacts is reduced by implementing the hysteresis.

In a further embodiment, the quality result is favored with respect to the transient detection result when the quality result indicates a strong quality advantage for one coding algorithm. Then, the encoding algorithm having the much better quality result than the other encoding algorithm is selected irrespective of whether the signal is a transient signal or not. On the other hand, the transient detection result can become decisive when the quality difference between both encoding algorithms is not so high. To this end, it is advantageous to not only determine a binary quality result, but a quantitative quality result. A binary quality result would only indicate which encoding algorithm results in a better quality, whereas a quantitative quality result not only determines which encoding algorithm results in a better quality, but how much better the corresponding encoding algorithm is. On the other hand, one could also use a quantitative transient detection result but, basically, a binary transient detection result would be sufficient as well.

Hence, the present invention provides a particular advantage with respect to a good compromise between bitrate on the one hand and quality on the other hand, since, for transient signals, the coding algorithm resulting in less quality is selected. When the quality result favors e.g. a TCX decision, nevertheless the ACELP mode is taken, which might result in a slightly reduced audio quality but, in the end, results in a higher coding gain associated with using the ACELP mode.

When, on the other hand, the quality result favors an ACELP frame, a TCX decision is, nevertheless, taken for non-transient signals. Hence, the slightly less coding gain is accepted in favor of a better audio quality.

Thus, the present invention results in an improved compromise between quality and bitrate due to the fact that not only the quality of the encoded and again decoded signal is considered but, in addition, also the actually to be encoded input signal is analyzed with respect to its transient characteristic and the result of this transient analysis is used to additionally influence the decision for an algorithm better suited for transient signals or an algorithm better suited for stationary signals.

### BRIEF DESCRIPTION OF THE DRAWINGS

Embodiments of the present invention will be detailed subsequently referring to the appended drawings, in which:

FIG. 1 illustrates a block diagram of an apparatus for coding a portion of an audio signal in accordance with an embodiment;

FIG. 2 illustrates a table for two different encoding algorithms and the signals for which they are suited;

FIG. 3 illustrates an overview over the quality condition, the transient condition and the hysteresis condition, which can be applied independently of each other, but which are, advantageously, applied jointly;

FIG. 4 illustrates a state table indicating whether a switch-over is performed or not for different situations;

FIG. 5 illustrates a flowchart for determining the transient result in an embodiment;

FIG. 6a illustrates a flowchart for determining the quality result in an embodiment;

FIG. 6b illustrates more details on the quality result of FIG. 6a; and

FIG. 7 illustrates a more detailed block diagram of an apparatus for coding in accordance with an embodiment.

### DETAILED DESCRIPTION OF THE INVENTION

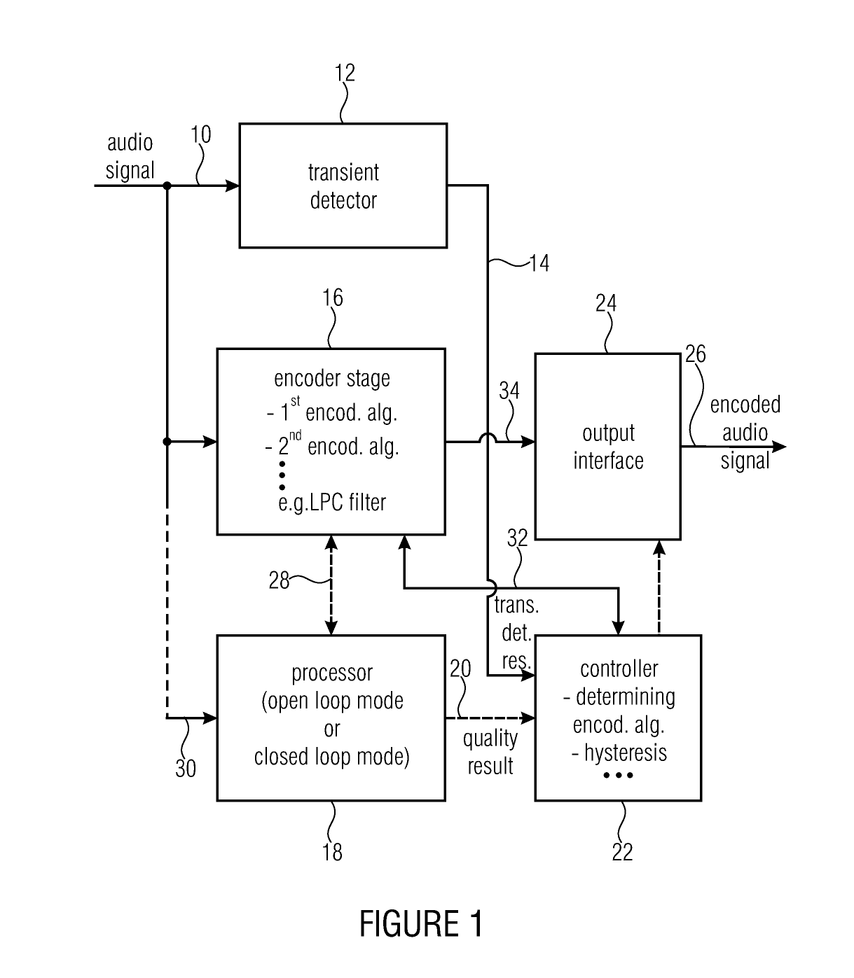

FIG. 1 illustrates an apparatus for coding a portion of an audio signal provided at an input line 10. The portion of the audio signal is input into a transient detector 12 for detecting whether a transient signal is located in the portion of the audio signal to obtain a transient detection result on line 14. Furthermore, an encoder stage 16 is provided where the encoder stage is configured for performing a first encoding algorithm on the audio signal, the first encoding algorithm having a first characteristic. Furthermore, the encoder stage 16 is configured for performing a second encoding algorithm on the audio signal, wherein the second encoding algorithm has a second characteristic which is different from the first characteristic.

Additionally, the apparatus comprises a processor 18 for determining which encoding algorithm of the first and second encoding algorithms results in an encoded audio signal being a better approximation to the portion of the original audio signal. The processor 18 generates a quality result based on this determination on line 20. The quality result on line 20 and the transient detection result on line 14 are both provided to a controller 22. The controller 22 is configured for determining whether the encoded audio signal for the portion of the audio signal is generated by either the first encoding algorithm or the second encoding algorithm. For this determination, not only the quality result 20, but also the transient detection result 14 are used. Furthermore, an output interface 24 is optionally provided where the output interface outputs an encoded audio signal as, for example, a bitstream or a different representation of an encoded signal on line 26.

In an implementation, where the encoder stage 16 performs an analysis by synthesis processing, the encoder stage 16 receives the same portion of the audio signal and encodes a portion of this audio signal by the first encoding algorithm to obtain the first encoded representation of the portion of the audio signal. Furthermore, the encoder stage generates an encoded representation of the same portion of the audio signal using the second encoding algorithm. Furthermore, the encoder stage 16 comprises, in this analysis by synthesis processing, decoders for both the first encoding algorithm and the second encoding algorithm. One corresponding decoder decodes the first encoded representation using a decoding algorithm associated with the first encoding algorithm. Furthermore, a decoder for performing a further decoding algorithm associated with the second encoding algorithm is provided so that, in the end, the encoder stage not only has the two encoded representations for the same portion of the audio signal, but also the two decoded signals for the same portion of the original audio signal on line 10. These two decoded signals are then provided to the processor via line 28 and the processor compares both decoded representations with the same portion of original audio signal obtained via input 30. Then, a segmental SNR for each encoding algorithm is determined This so-called quality result provides, in an embodiment, not only an indication of the better coding algorithm, i.e., a binary signal whether the first encoding algorithm or the second encoding algorithm has resulted in a better SNR. Additionally, the quality result indicates a quantitative information, i.e., how much better, for example in dB, the corresponding encoding algorithm is.

In this situation, the controller, when fully relying on the quality result 20, accesses the encoder stage via line 32 so that the encoder stage forwards the already stored encoded representation of the corresponding encoding algorithm to the output interface 24 so that this encoded representation represents the corresponding portion of the original audio signal in the encoded audio signal.

Alternatively, when the processor 18 performs an open-loop mode for determining the quality result, it is not necessary that both encoding algorithms are applied to one and the same audio signal portion. Instead, the processor 18 determines which encoding algorithm is better and, then, the encoder stage 16 is controlled via line 28 to only apply the encoding algorithm indicated by the processor and, then, this encoded representation resulting from the selected encoding algorithm is provided to the output interface 24 via line 34.

Depending on the specific implementation of the encoder stage 16, both encoding algorithms may operate in the LPC domain. In this case, such as for ACELP as the first encoding algorithm and TCX as the second encoding algorithm, a common LPC pre-processing is performed. This LPC pre-processing may comprise an LPC analysis of the portion of the audio signal, which determines the LPC coefficients for the portion of the audio signal. Then, an LPC analysis filter is adjusted using the determined LPC coefficients, and the original audio signal is filtered by this LPC analysis filter. Then, the encoder stage calculates a sample-wise difference between the output of the LPC analysis filter and the audio input signal in order to calculate the LPC residual signal which is then subjected to the first encoding algorithm or the second encoding algorithm in an open-loop mode or which is provided to both encoding algorithms in a closed-loop mode as described before. Alternatively, the filtering by the LPC filter and the sample-wise determination of the residual signal can be replaced by the FDNS (frequency domain noise shaping) technology described in the USAC standard.

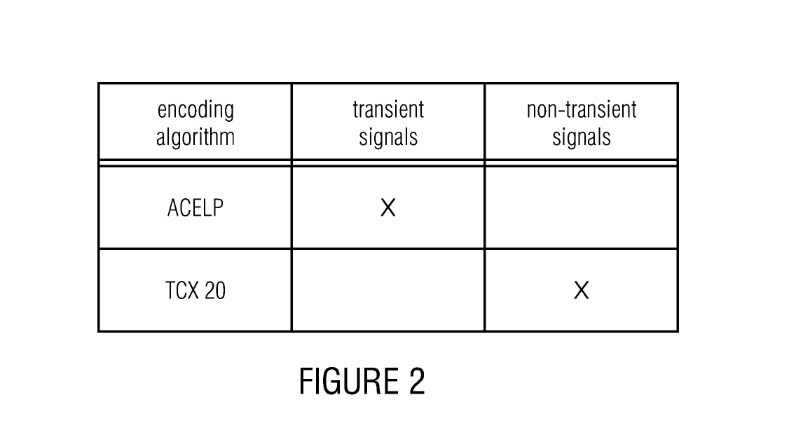

FIG. 2 illustrates an advantageous implementation of the encoder stage. As the first encoding algorithm, the ACELP encoding algorithm having an CELP encoding characteristic is used. Furthermore, this encoding algorithm is better suited for transient signals. The second encoding algorithm has a coding characteristic which makes this second encoding algorithm better suited for non-transient signals. Exemplarily, a transform excitation coding algorithm such as TCX is used and, particularly, a TCX 20 encoding algorithm is advantageous which has a frame length of 20 ms (the window length can be higher due to an overlap) which makes the coding concept illustrated in FIG. 1 particularly suitable for low-delay implementations which may be used in real-time scenarios such as scenarios where there is a two-way communication as in telephone applications and, particularly, in mobile or cellular telephone applications.

However, the present invention is additionally useful in other combinations of first and second encoding algorithms. Exemplarily, the first encoding algorithm better suited for transient signals may comprise any of well-known time-domain encoders such as GSM-used encoders (G.729) or any other time-domain encoders. The non-transient signal encoding algorithm, on the other hand, can be any well-known transform-domain encoder such as MP3, AAC, AC3 or any other transform or filterbank-based audio encoding algorithm. For a low-delay implementation, however, the combination of ACELP on the one hand and TCX on the other hand, wherein, particularly, the TCX encoder can be based on an FFT or even more advantageously on an MDCT with a short window length is advantageous. Hence, both encoding algorithms operate in the LPC domain obtained by transforming the audio signal into the LPC domain using an LPC analysis filter. However, the ACELP then operates in the LPC-“time”-domain, while the TCX encoder operates in the LPC-“frequency”-domain.

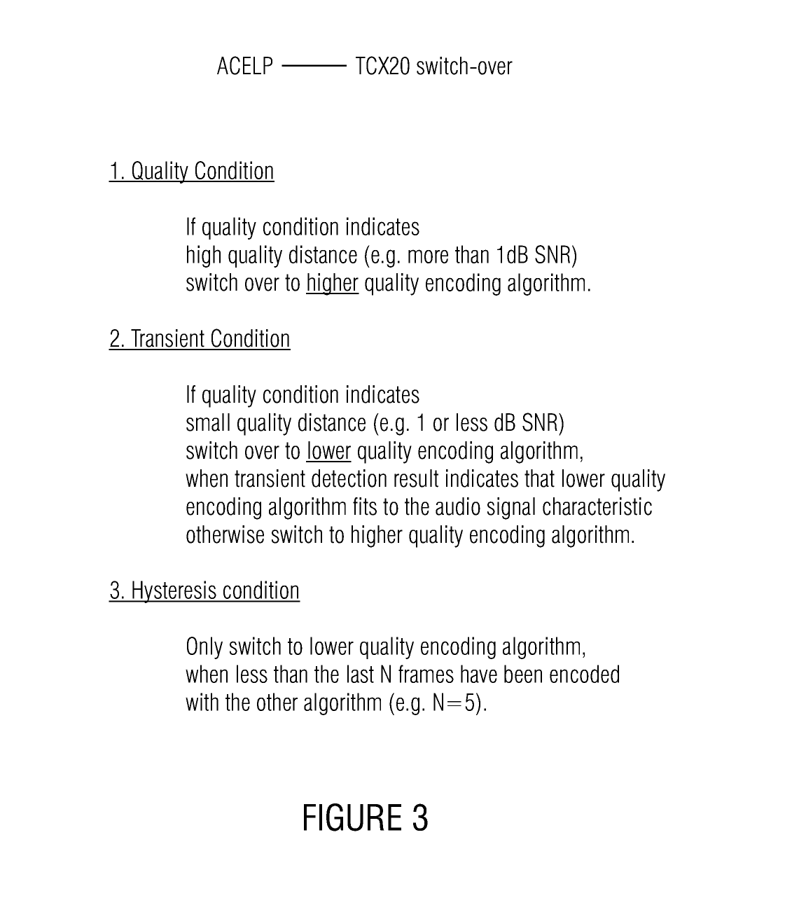

Subsequently, an advantageous implementation of the controller 22 of FIG. 1 is discussed in the context of FIG. 3.

Advantageously, the switchover between the first encoding algorithm such as ACELP and the second encoding algorithm such as TCX 20 is performed using three conditions. The first condition is the quality condition represented by the quality result 20 of FIG. 1. The second condition is the transient condition represented by the transient detection result on line 14 of FIG. 1. The third condition is a hysteresis condition which relies on the decisions made by the controller 22 in the past, i.e., for the earlier portions of the audio signal.

The quality condition is implemented such that a switchover to the higher quality encoding algorithm is performed when the quality condition indicates a large quality distance between the first encoding algorithm and the second encoding algorithm. When, for example, it is determined that one encoding algorithm outperforms the other encoding algorithm by, for example, one dB SNR difference, then the quality condition determines a switchover or, stated differently, the actually used encoding algorithm for the actually considered portion of the audio signal irrespective of any transient detection or hysteresis situation.

When, however, the quality condition only indicates a small quality distance between both encoding algorithms such as the quality distance of one or less dB SNR difference, a switch over to the lower quality encoding algorithm may occur, when the transient detection result indicates that the lower quality encoding algorithm fits to the audio signal characteristic, i.e., whether the audio signal is transient or not. When, however, the transient detection result indicates that the lower quality encoding algorithm does not fit to the audio signal characteristic, then the higher quality encoding algorithm is to be used. In the latter case, once again, the quality condition determines the result, but only when a specific match between the lower quality encoding algorithm and the transient/stationary situation of the audio signal do not fit together.

The hysteresis condition is particularly useful in a combination with the transient condition, i.e., in that the switch to the lower quality encoding algorithm is only performed when less than the last N frames have been encoded with the other algorithm. In advantageous embodiments, N is equal to five frames, but other values advantageously lower or equal to N frames or signal portions, each comprising a minimum number of samples above e.g. 128 samples, can be used as well.

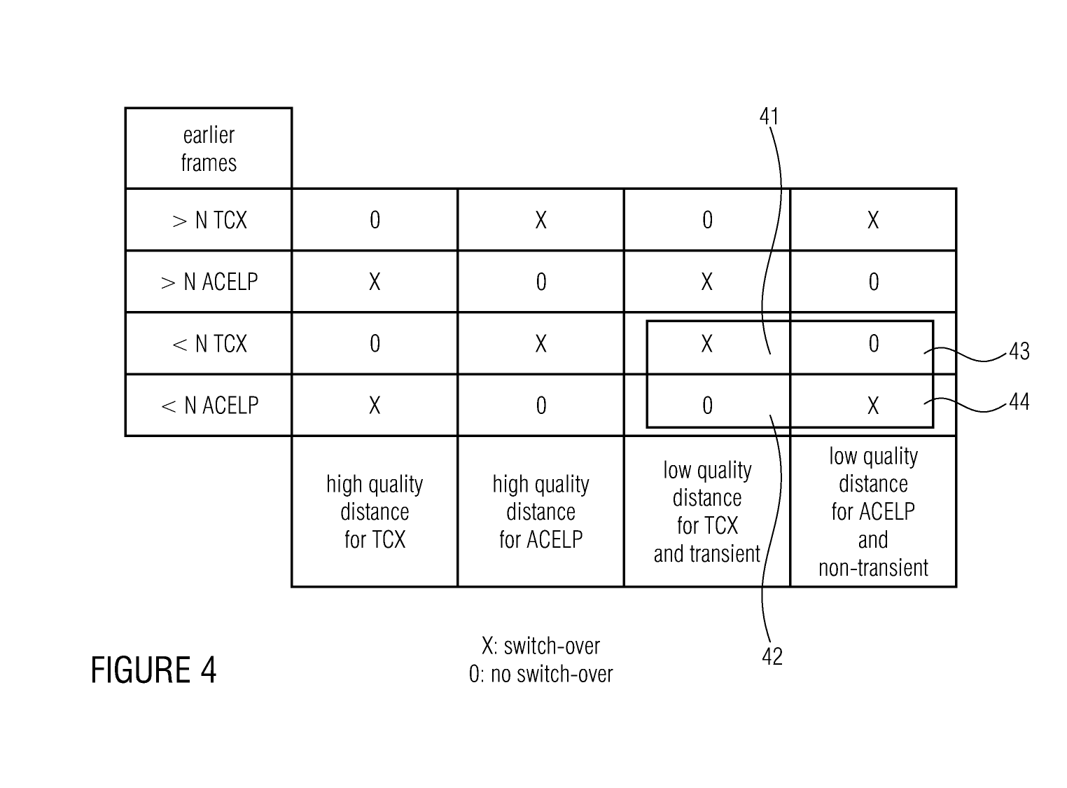

FIG. 4 illustrates a table of state changes depending on certain situations. The left column indicates the situation where the number of earlier frames is greater than N or smaller than N for either TCX or ACELP.

The last line indicates whether there is a large quality distance for TCX or a large quality distance for ACELP. In these two cases, which are the first two columns, a change is performed where indicated by an “X”, while a change is not performed as indicated by “0”.

Furthermore, the last two columns indicate the situation when a small quality distance for TCX is determined and when a transient signal is detected or when a small quality distance for an ACELP is determined and the signal portion is detected as being non-transient.

The first two lines of the last two columns both indicate that the quality result is decisive when the number of earlier frames is greater than 10. Hence, when there is a strong indication from the past for one coding algorithm, then the transient detection does not play a role, either.

When, however, the number of earlier frames being encoded in one of the two encoding algorithms is smaller than N, a switchover is performed from TCX to ACELP indicated at field 40 for transient signals. Additionally, as indicated in field 41, a change from ACELP to TCX is performed even when there is a small quality distance in favor of ACELP due to the fact that we have a non-transient signal. When the number of the last LCLP frames is smaller than N the subsequent frame is also encoded with ACELP and, therefore, no switchover is necessary as indicated at field 42. When, additionally, the number of TCX frames is smaller than N and when there is a small quality distance for ACELP and the signal is non-transient, the current frame is encoded using TCX and, no switchover is necessary as indicated by field 43. Hence, the influence of the hysteresis is clearly visible by comparing fields 42, 43 with the four fields above these two fields.

Hence, the present invention advantageously influences the hysteresis for the closed-loop decision by the output of a transient detector. Therefore, there does not exist, as in AMR-WB+, a pure closed-loop decision whether TCX or ACELP is taken. Instead, the closed-loop calculation is influenced by the transient detection result, i.e., every transient signal portion is determined in the audio signal. The decision whether an ACELP frame or TCX frame is calculated, therefore does not only depend on the closed-loop calculations, or, generally, the quality result, but additionally depends on whether a transient is detected or not.

In other words, the hysteresis for determining which encoding algorithm is to be used for the current frame can be expressed as follows:

When the quality result for TCX is slightly smaller than the quality result for ACELP, and when the currently considered signal portions or just the current frame is not transient, then TCX is used instead of ACELP.

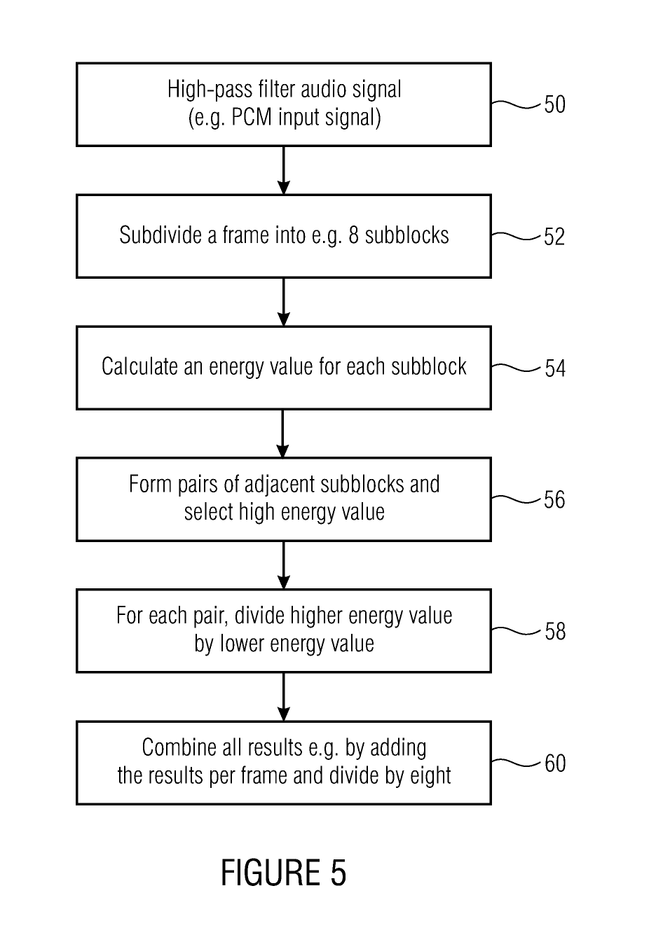

When, on the other hand, the quality result for ACELP is slightly smaller than the quality result for TCX, and when the frame is transient, then ACELP is used instead of TCX. Advantageously, a flatness measure is calculated as the transient detection result, which is a quantitative number. When the flatness is greater than or equal to a certain value, then the frame is determined to be transient. When, on the other hand, the flatness is smaller than this threshold value, then it is determined that the frame is non-transient. As a threshold, the flatness measure of two is advantageous, where the calculation of the flatness is described in FIG. 5 in more detail.

Furthermore, as to the quality result, a quantitative measure is advantageous. When an SNR measure or, particularly, a segmental SNR measure is used, then the term “slightly smaller” as used before, may mean one dB smaller. Hence, when the SNRs for TCX and ACELP are more different from each other or stated differently, when the absolute difference between both SNR values is greater than one dB, then the quality condition of FIG. 3 alone determines the encoding algorithm for the current audio signal portion.

The above described decision can be furthermore elaborated, when the transient detection or the hysteresis output or the SNR of TCX or ACELP of the past or earlier frames is included into the if condition. Hence, a hysteresis is built which, for one embodiment, is illustrated in FIG. 3 as condition no. 3. Particularly, FIG. 3 illustrated the alternative when the hysteresis output, i.e., the determination for the past is used for modifying the transient condition.

Alternatively, a further hysteresis condition being based on the earlier TCX or ACELP-SNRs may comprise that a determination for the lower quality encoding algorithm is only performed when a change of the SNR difference with respect to the earlier frame is lower than, for example, a threshold. A further embodiment may comprise the usage of the transient detection result for one or more earlier frames when the transient detection result is a quantitative number. Then, a switchover to the lower quality encoding algorithm may, for example, only be performed when a change of quantitative transient detection result from the earlier frame to the current frame is, again, below a threshold. Other combinations of these figures for further modifying the hysteresis condition 3 of FIG. 3 can prove to be useful in order to obtain a better compromise between the bitrate on the one hand and the audio quality on the other hand.

Furthermore, the hysteresis condition as illustrated in the context of FIG. 3 and as described before can be used instead of or in addition to a further hysteresis which, for example, is based on internal analysis data of the ACELP and TCX encoding algorithms.

Subsequently, reference is made to FIG. 5 for illustrating the advantageous determination of the transient detection result on line 14 of FIG. 1.

In step 50, the time-domain audio signal such as a PCM input signal on line 10 is high-pass filtered to obtain a high-pass filtered audio signal. Then, in step 52, the frame of the high-pass filtered signal which can be equal to the portion of the audio signal is sub-divided into a plurality of, for example, eight sub-blocks. Then, in step 54, an energy value for each sub-block is calculated. This energy calculation can comprise a squaring of each sample value in the sub-block and a subsequent addition of the squared samples with or without an averaging. Then, in step 56, pairs of adjacent sub-blocks are formed. The pairs can comprise a first pair consisting of the first and the second sub-block, a second pair consisting of the second and third sub-block, a third pair consisting of the third and fourth sub-block, etc. Additionally, a pair comprising the last sub-block of the earlier frame and the first sub-block of the current frame can be used as well. Alternatively, other ways of forming pairs can be performed such as, for example, only forming pairs of the first and second sub-block, of the third and fourth sub-block, etc. Then, as also outlined in block 56 of FIG. 5, the higher energy value of each sub-block pair is selected and, as outlined in step 58, divided by the lower energy value of the sub-block pair. Then, as outlined in block 60 of FIG. 5, all results of step 58 for a frame are combined. This combination may consist of an addition of the results of block 58 and an averaging where the result of the addition is divided by the number of pairs such as eight, when eight pairs per sub-block were determined in block 56. The result of block 60 is the flatness measure which is used by the controller 22 in order to determine whether a signal portion is transient or not. When the flatness measure is greater than or equal to 2, a transient signal portion is detected, while, when the flatness measure is lower than 2, it is determined that a signal is non-transient or stationary. However, other thresholds between 1.5 and 3 can be used as well, but it has been shown that the threshold of two provides the best results.

It is to be noted that other transient detectors can be used as well. Transient signals may additionally comprise voiced speech signals. Traditionally, transient signals comprise applause like signals or castagnets or speech plosives comprising signals obtained by speaking characters “p” or “t” or the like. However, vocals such as “a”, “e”, “i”, “o”, “u” are not meant to be transient signals in the classical approach, since same are characterized by periodic glottal or pitch pulses. However, since vocals also represent voiced speech signals, vocals are also considered to be transient signals for the present invention. The detection of those signals can be done, in addition or alternative to the procedure in FIG. 5, by speech detectors distinguishing voiced speech from unvoiced speech or by evaluating metadata associated with an audio signal and indicating, to a metadata evaluator, whether the corresponding portion is a transient or non-transient portion.

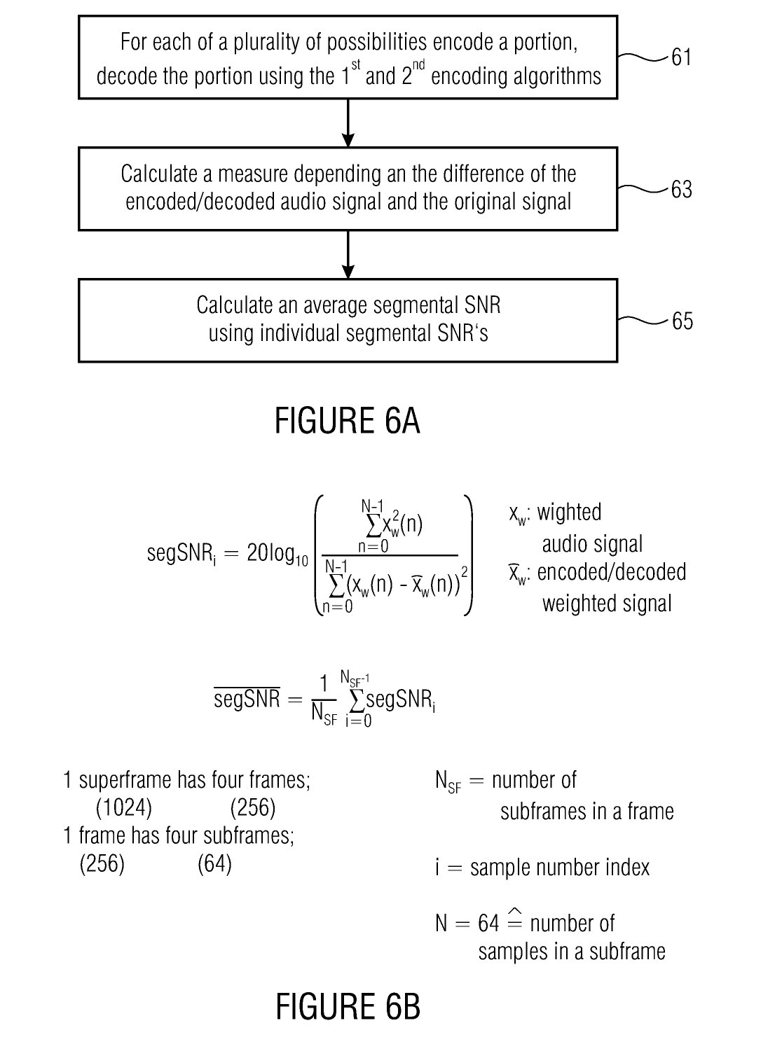

Subsequently, FIG. 6a is described in order to illustrate the third way of calculating the quality result on line 20 of FIG. 1, i.e., how the processor 18 is advantageously configured.

In block 61, a closed-loop procedure is described where, for each of a plurality of possibilities, a portion is encoded and decoded using the first and second coding algorithms. Then, in step 63, a measure such as a segmental SNR is calculated depending on the difference of the encoded and again decoded audio signal and the original signal. This measure is calculated for both encoding algorithms.

Then, an average segmental SNR using the individually segmental SNRs is calculated in step 65, and this calculation is again performed for both encoding algorithms so that, in the end, step 65 results in two different averaged SNR values for the same portion of the audio signal. The difference between these segmented SNR values for a frame is used as the quantitative quality result on line 20 of FIG. 1.

FIG. 6b illustrates two equations, where the upper equation is used in block 63, and where the lower equation is used in block 65. \hat{x}_{w} stands for the weighted audio signal, and \hat{x}_{w} stands for the encoded and again decoded weighted signal.

The averaging performed in block 65 is an averaging over one frame, where each frame consists of a number of subframes N_{SF}, and where four such frames together form a superframe. Hence, a superframe comprises 1024 samples, an individual frame comprises 2056 samples, and each subframe, for which the upper equation in FIG. 6b or step 63 is performed, comprises 64 samples. In the upper equation used in block 63, n is the sample number index and N is the maximum number of samples in the subframe equal to 63 indicating that a subframe has 64 samples.

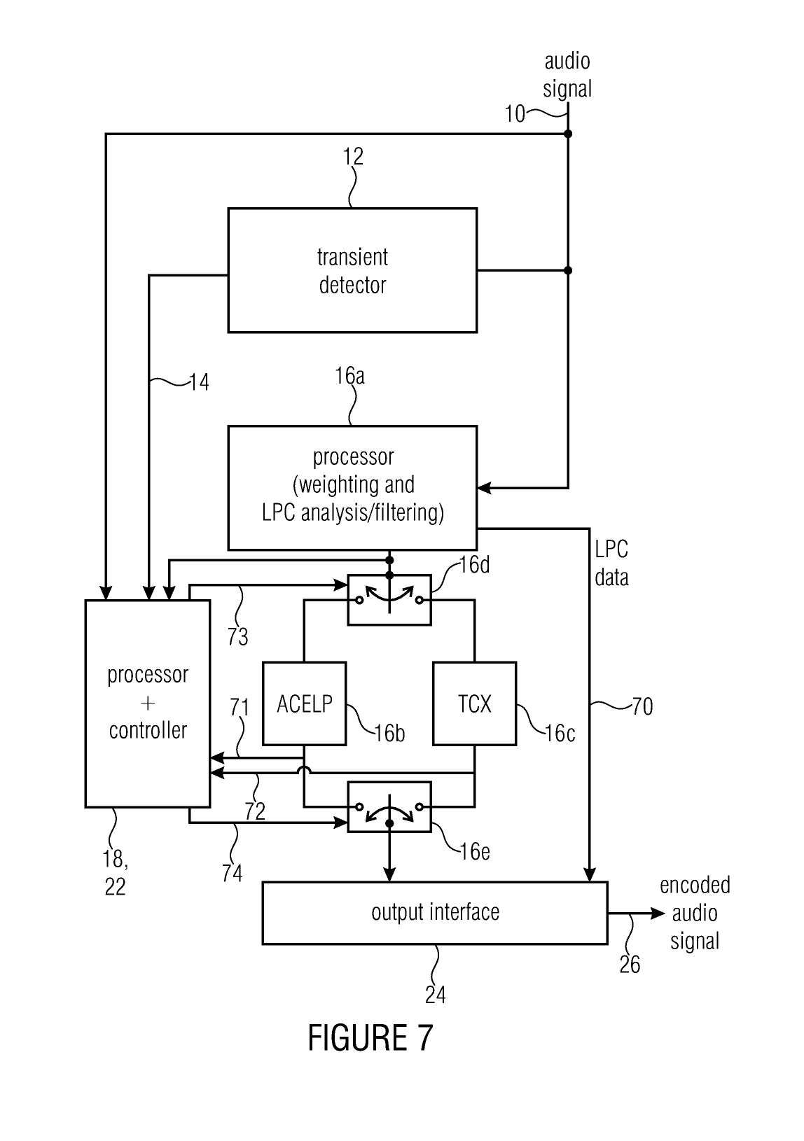

FIG. 7 illustrates a further embodiment of the inventive apparatus for encoding, similar to the FIG. 1 embodiment, and the same reference numerals indicate similar elements. However, FIG. 7 illustrates a more detailed representation of the encoder stage 16, which comprises a pre-processor 16a for performing a weighting and LPC analysis/filtering, and the pre-processor block 16a provides LPC data on line 70 to the output interface 24. Furthermore, the encoder stage 16 of FIG. 1 comprises the first encoding algorithm at 16b and the second encoding algorithm at 16c which are the ACELP encoding algorithm and the TCX encoding algorithm, respectively.

Furthermore, the encoder stage 16 may comprise either a switch 16d connected before the blocks 16d, 16c or a switch 16e connected subsequent to the blocks 16b, 16c, where “before” and “subsequent” refer to the signal flow direction which is at least with respect to block 16a to 16e from top to bottom of FIG. 7. Block 16d will not be present in a closed-loop decision. In this case, only switch 16e will be present, since both encoding algorithms 16b, 16c operate on one and the same portion of the audio signal and the result of the selected encoding algorithm will be taken out and forwarded to the output interface 24.

If, however, an open-loop decision or any other decision is performed before both encoding algorithms operate on one and the same signal, then switch 16e will not be present, but the switch 16d will be present, and each portion of the audio signal will only be encoded using either one of blocks 16b, 16c.

Furthermore, particularly for the closed-loop mode, the outputs of both blocks are connected to the processor and controller block 18, 22 as indicated by lines 71, 72. The switch control takes place via lines 73, 74 from the processor and controller block 18, 22 to the corresponding switches 16d, 16e. Again, depending on the implementation, only one of lines 73, 74 will typically be there.

The encoded audio signal 26 therefore, comprises, among other data, the result of an ACELP or TCX which will typically be redundancy-encoded in addition such as by Huffman-coding or arithmetic coding before being input into the output interface 24. Additionally, the LPC data 70 are provided to the output interface 24 in order to be included in the encoded audio signal. Furthermore, it is advantageous to additionally include a coding mode decision into the encoded audio signal indicating to a decoder that the current portion of the audio signal is an ACELP or a TCX portion.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a non-transitory data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are advantageously performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus for coding a portion of an audio signal to acquire an encoded audio signal for the portion of the audio signal, comprising:
a transient detector for detecting whether a transient signal is located in the portion of the audio signal to achieve a transient detection result;
an encoder stage for performing a first encoding algorithm on the audio signal, the first encoding algorithm comprising a first characteristic, and for performing a second encoding algorithm on the audio signal, the second encoding algorithm comprising a second characteristic being different from the first characteristic;
a processor for determining which encoding algorithm results in an encoded audio signal being a better approximation to the portion of the audio signal with respect to the other encoding algorithm to achieve a quality result; and
a controller for determining whether the encoded audio signal for the portion of the audio signal is to be generated by either the first encoding algorithm or the second encoding algorithm based on the transient detection result and the quality result.

2. The apparatus in accordance with claim 1, wherein the encoder stage is configured for using a first encoding algorithm which is better suited for transient signals than the second encoding algorithm.

3. The apparatus of claim 2, wherein the first encoding algorithm is an ACELP coding algorithm, and wherein the second encoding algorithm is a transform coding algorithm.

4. The apparatus in accordance with claim 1, wherein the controller is configured for determining the second encoding algorithm, although the quality result indicates a better quality for the first encoding algorithm, when the transient detection result indicates a non-transient signal.

5. The apparatus in accordance with claim 1, wherein the controller is configured for determining the first encoding algorithm, although the quality result indicates a better quality for the second encoding algorithm, when the transient detection result indicates a transient signal.

6. The apparatus in accordance with claim 4, wherein the controller is configured for determining the second encoding algorithm or the first encoding algorithm only when the quality result indicates a quality different between the encoding algorithms, which is smaller than a threshold difference value.

7. The apparatus in accordance with claim 6, wherein the threshold is equal to or lower than 3 dB, and wherein the quality result for both encoding algorithms are calculated using an SNR calculation between the audio signal and an encoded and again decoded version of the audio signal.

8. The apparatus in accordance with claim 4, wherein the controller is configured to only determine the second encoding algorithm or the first encoding algorithm, when a number of earlier signal portions for which the first or second encoding algorithm has been determined is smaller than a predetermined number.

9. The apparatus in accordance with claim 8, wherein the controller is configured to use a predetermined value being smaller than 10.

10. The apparatus in accordance with claim 1,
wherein the controller is configured for applying a hysteresis processing so that the second encoding algorithm or the first encoding algorithm is only determined when the lower quality result indicates a lower quality for the second encoding algorithm or the first algorithm encoding, when a number of earlier signal portions comprising the first encoding algorithm or the second encoding algorithm, respectively, is equal or lower than a predetermined number, and when the transient detection result indicates a predefined state of the two possible states comprising non-transients and transients.

11. The apparatus in accordance with claim 1, wherein the transient detector is configured to perform the following:
high-pass filtering of the audio signal to acquire a high-pass filtered signal block;
subdividing of the high-pass filtered signal block into a plurality of sub-blocks;
calculating an energy for each sub-block;
combining of the energy values for each pair of adjacent sub-blocks to achieve a result for each pair; and
combining of the results for the pairs to achieve the transient detection result.

12. The apparatus in accordance with claim 1, wherein the encoder stage further comprises an LPC filtering stage for determining LPC coefficients from the audio signal for filtering the audio signal using an LPC analysis filter determined by the LPC coefficients to determine a residual signal, wherein the first encoding algorithm or the second encoding algorithm is applied to the residual signal, and
wherein the encoded audio signal further comprises information on the LPC coefficients.

13. The apparatus in accordance with claim 1,
wherein the encoding stage either comprises a switch connected to the first encoding algorithm and the second encoding algorithm or a switch connected subsequently to the first encoding algorithm and the second encoding algorithm, wherein the switch is controlled by the controller.

14. A method of coding a portion of an audio signal to acquire an encoded audio signal for the portion of the audio signal, comprising:
detecting whether a transient signal is located in the portion of the audio signal to achieve a transient detection result;
performing a first encoding algorithm on the audio signal, the first encoding algorithm comprising a first characteristic, and performing a second encoding algorithm on the audio signal, the second encoding algorithm comprising a second characteristic being different from the first characteristic;
determining which encoding algorithm results in an encoded audio signal being a better approximation to the portion of the audio signal with respect to the other encoding algorithm to achieve a quality result; and
determining whether the encoded audio signal for the portion of the audio signal is to be generated by either the first encoding algorithm or the second encoding algorithm based on the transient detection result and the quality result.

15. A computer program comprising a program code for performing, when running on a computer, the method of coding a portion of an audio signal in accordance with claim 14.
